(19) United States
(12) Patent Application Publication
(10) Pub. No.: US 2021/0243520 A1
(43) Pub. Date: Aug. 5, 2021

(54) SPEAKER UNIT

(71) Applicant: DENSO TEN Limited, Kobe-shi (JP)

(72) Inventors: Yuuichi NAKAJIMA, Kobe-shi (JP); Kazuhiko HAMADA, Kobe-shi (JP); Keiichiroh TANAKA, Kobe-shi (JP); Migiwa GOTO, Kobe-shi (JP)

(73) Assignee: DENSO TEN Limited, Kobe-shi (JP)

(21) Appl. No.: 17/115,914

(22) Filed: Dec. 9, 2020

(30) Foreign Application Priority Data
Feb. 4, 2020 (JP) 2020-017439

(51) Int. Cl. H04R 1/28; H04R 1/02

(52) U.S. Cl. CPC H04R 1/2896; H04R 1/025; H04R 9/025; H04R 2499/13; H04R 2400/11; H04R 1/288

(57) ABSTRACT

A speaker unit has at least a part that is installed in a first space separated by a wall from a second space in which a sound to be output by the speaker unit is listened to. The speaker unit includes a first speaker, a second speaker, a speaker connector that interconnects the first speaker and the second speaker so that back surfaces of the first speaker and the second speaker oppose each other, a first spacer that interconnects the first speaker and a first opening of the wall, and a second spacer that interconnects the second speaker and a second opening of the wall. The first speaker, the second speaker, the speaker connector, the first spacer and the second spacer are integrally connected to each other.

### BACKGROUND OF THE INVENTION

### Field of the Invention

The invention relates to a speaker unit.

### Description of the Background Art

A speaker apparatus has a structure in which a speaker unit having, for example, a diaphragm (cone, etc.), a voice coil, a magnet, and the like, is installed on a predetermined surface of an enclosure (housing). In such a speaker apparatus, vibration along with driving of the speaker unit is transmitted to the enclosure and vibrates the enclosure itself and peripheral devices of the enclosure so that unnecessary sound may occur. Therefore, in the speaker apparatus disclosed in Japanese Published Unexamined Patent Application No. 2004-015565, a shaft interconnects two speakers and is connected to back surfaces of the two speakers so as to cancel the vibration.

Generally, in order to effectively output sound from the speaker unit, there needs to be a space with sufficient volume on a back-surface side of the speaker unit. For example, in the Japanese Published Unexamined Patent Application No. 2004-015565, it is possible to provide a sufficient back-surface space by utilizing a space of a trunk room of a vehicle. However, in the Japanese Published Unexamined Patent Application No. 2004-015565, there has been a problem that a shape of a portion in which the speaker unit is installed becomes complicated and it is difficult to mount the speaker unit by utilizing other spaces of the vehicle as the back-surface space.

### SUMMARY OF THE INVENTION

According to one aspect of the invention, a speaker unit has at least a part that is installed in a first space separated by a wall from a second space in which a sound to be output by the speaker unit is listened to. The speaker unit includes a first speaker, a second speaker, a speaker connector that interconnects the first speaker and the second speaker so that back surfaces of the first speaker and the second speaker oppose each other, a first spacer that interconnects the first speaker and a first opening of the wall, and a second spacer that interconnects the second speaker and a second opening of the wall. The first speaker, the second speaker, the speaker connector, the first spacer and the second spacer are integrally connected to each other.

An object of the invention is to provide a speaker unit capable of utilizing a space (hereinafter, also referred to as “installation space”) as a back-surface space of a speaker and being easily installed, for example, when the speaker unit is installed in the space partitioned by a wall, such as a center console of a vehicle.

These and other objects, features, aspects and advantages of the invention will become more apparent from the following detailed description of the invention when taken in conjunction with the accompanying drawings.

### BRIEF DESCRIPTION OF THE DRAWINGS

FIG. 1 is an outside drawing of a speaker unit according to a first embodiment mounted inside a center console of a vehicle;

FIG. 2 is a schematic cross-sectional view illustrating an installation structure of the speaker unit shown in FIG. 1;

FIG. 3 illustrates one example of each of a first speaker and a second speaker;

FIG. 4 illustrates a speaker unit viewed from a side of the first speaker;

FIG. 5 is a perspective view of the speaker unit;

FIG. 6 is a partially exploded view of the speaker unit;

FIG. 7 illustrates a configuration of a speaker connector;

FIG. 8 is a perspective view of a speaker unit according to a first modification;

FIG. 9 is an exploded perspective view of the speaker unit according to the first modification;

FIG. 10 illustrates a speaker unit according to a second modification viewed from a front side of a speaker;

FIG. 11 is an exploded perspective view of the speaker unit according to the second modification;

FIG. 12 is a perspective view of the speaker unit according to the second modification;

FIG. 13 is a schematic cross-sectional view illustrating a configuration of a speaker unit according to a third modification;

FIG. 14 illustrates the speaker unit according to the third modification viewed from a side of a first speaker;

FIG. 15 is a schematic cross-sectional view illustrating a configuration of a speaker unit according to a second embodiment;

FIG. 16 is a partially exploded perspective view of the speaker unit according to the second embodiment; and

FIG. 17 illustrates a configuration of a speaker connector according to a fourth modification.

### DESCRIPTION OF THE EMBODIMENTS

### First Embodiment

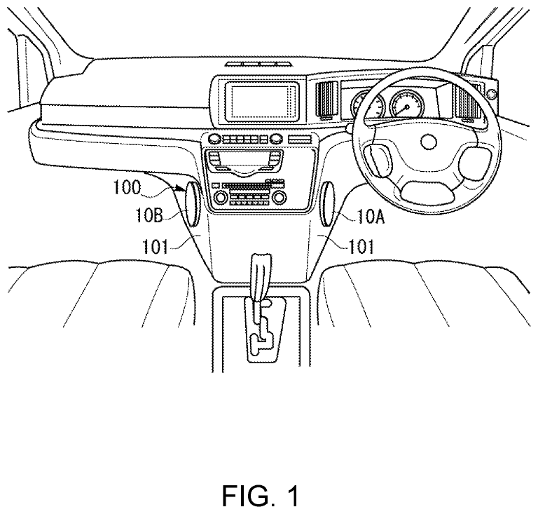

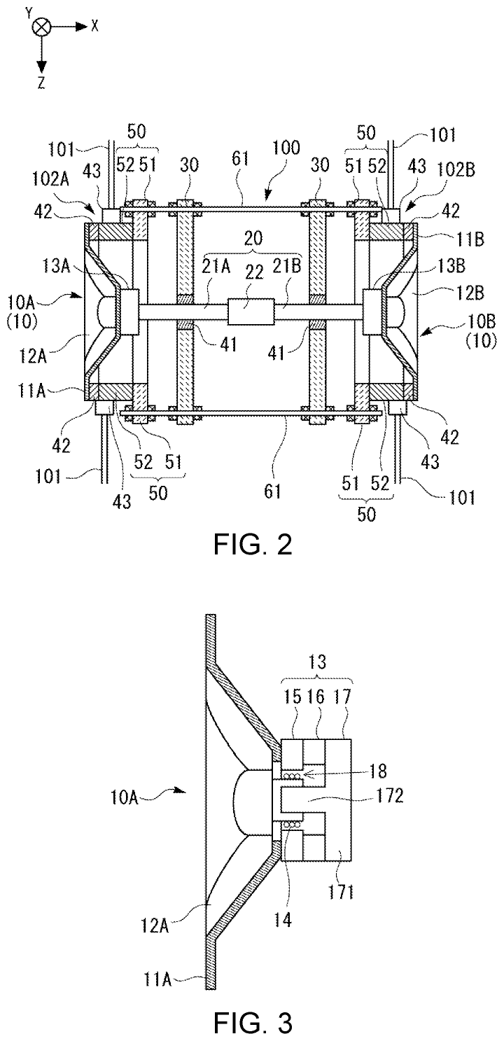

Embodiments of the invention will be described below with reference to the drawings. FIG. 1 is an outside drawing of a speaker unit 100 according to a first embodiment mounted inside a center console of a vehicle. FIG. 2 is a schematic cross-sectional view illustrating an installation structure of the speaker unit 100 shown in FIG. 1. In FIG. 2, an X-axis indicates a vehicle width direction, a Y-axis indicates a height direction, and a Z-axis indicates a front-rear direction of the vehicle. In the following drawings, each of the X-axis, the Y-axis and the Z-axis indicates the same direction as shown in FIG. 2. These directions are shown for convenience of illustration. The speaker unit 100 according to this embodiment is not limited to the speaker unit installed in the directions shown in FIG. 2.

In this embodiment, as illustrated in FIG. 1, the speaker unit 100 is installed inside the center console. The center console is provided with devices, such as an audio, a navigation device and an air-conditioner operating part, that are covered with a wall (hereinafter, referred to as “interior material”) 101 and is constituted of a protrusion protruded to a vehicle cabin. The interior material 101 conceals an internal structure and wires of the devices from a user's view of the vehicle and mainly functions as a partition material for improving an appearance. The interior material 101 divides a space into a space (a first space) inside the center console in which the speaker unit 100 is set and the vehicle cabin (a second space) in which a sound to be output from the speaker unit 100 is listened to.

For the interior material 101, for example, a material obtained by forming synthetic resin into a thin plate shape is used so that a vehicle weight is not excessively increased. The interior material 101 may have moderate flexibility so as to prevent a user from being damaged when the vehicle collides.

As illustrated in FIG. 2, the speaker unit 100 has a pair of speakers 10A and 10B, a speaker connector 20 that interconnects the pair of the speakers 10A and 10B, and a speaker cushioning material 42 arranged on each of frames 11A and 11B of the pair of the speakers 10A and 10B.

One of the pair of the speakers 10A and 10B is a first speaker 10A and the other is a second speaker 10B. The first speaker 10A has a first diaphragm 12A, a first magnetic circuit 13A that vibrates the first diaphragm 12A, and the first frame 11A that holds the first diaphragm 12A and the first magnetic circuit 13A. The second speaker 10B has a second diaphragm 12B, a second magnetic circuit 13B that vibrates the second diaphragm 12B, and the second frame 11B that holds the second diaphragm 12B and the second magnetic circuit 13B.

The first speaker 10A and the second speaker 10B desirably have the same configuration, but may have different diameters, shapes, and the like. In this embodiment, an electrodynamic speaker having a magnetic circuit and a voice coil will be described as an example, but a type of the speaker is not limited to this. For example, the speaker may be an electrostatic speaker in which a high voltage acoustic signal is applied between a fixed electrode and a diaphragm to generate an electrostatic force that causes the diaphragm to vibrate or may be a piezoelectric/magnetostriction speaker in which an actuator having a piezoelectric element or a magnetostrictive element causes the diaphragm to vibrate. In this case, for example, in the electrostatic speaker, fixed electrodes of two speakers may be opposite to each other and connected to each other and, in the piezoelectric/magnetostriction speaker, back surfaces of the actuators may be opposite to each other and connected to each other.

FIG. 3 illustrates one example of each of the first speaker 10A and the second speaker 10B. In this embodiment, since the first speaker 10A and the second speaker 10B have the same configuration, the first speaker 10A and second speaker 10B are also referred to as “speaker 10” when description is made without distinguishing individual speakers. The first frame 11A and the second frame 11B, the first diaphragm 12A and the second diaphragm 12B, and the first magnetic circuit 13A and the second magnetic circuit 13B are also referred to as “frame 11”, “diaphragm 12” and “magnetic circuit 13”, respectively, when description is made for each part of the speaker 10 regardless of a numeral “first” or “second”.

In the speaker 10, a side on which the diaphragm 12 is arranged is referred to as an anterior (front) surface of the speaker 10, and a side on which the magnetic circuit 13 is arranged is referred to as a rear (back) surface of the speaker 10. The diaphragm 12 illustrated in FIG. 3 has a cone shape. At least an outer edge of the cone is installed to the frame 11 and a drive coil (voice coil 14) is installed on a vertex side, i.e., rear side of the cone. Both ends of the drive coil 14 are electrically connected to input terminals of the speaker 10 via lead wires (not shown) and an audio signal (electrical signal) is input.

A plate 15 formed by a magnetic material is installed on a rear surface of the frame 11. The plate 15 is formed in a thin and substantially annular shape.

A magnet 16 having an annular shape is arranged on a rear surface of the plate 15 and a yoke 17 is installed on a rear surface of the magnet 16. The yoke 17 is integrally formed by a base 171 having a disk shape and a center pole 172 projecting forward from a center of the base 171, and the center pole 172 is, for example, cylindrically formed. The yoke 17 is installed so that an anterior surface of the base 171 is installed on the rear surface of the magnet 16.

The frame 11, the plate 15, the magnet 16, and the yoke 17 are connected to each other such that respective centers thereof are aligned with each other in a front view. An anterior surface of the center pole 172 of the yoke 17 and an anterior surface of the plate 15 are positioned in the same plane and a space between the plate 15 and the center pole 172 is formed as a magnetic gap 18.

The drive coil 14 is fitted to a front-end side of the center pole 172 and is arranged so as to be positionally changed (movable) in a front-rear direction, i.e., an axis direction of the center pole 172. At least a part of the drive coil 14 is positioned in the magnetic gap 18 and when the audio signal is input, the drive coil 14 is vibrated by interaction (Lorentz force) between current due to the audio signal and magnetic flux of the magnetic gap 18. The diaphragm 12 is vibrated in accordance with the vibration of the drive coil 14, and the vibration of the diaphragm 12 vibrates surrounding air, whereby sound is generated in accordance with the audio signal. Therefore, the vibration is transmitted to the frame 11 and the magnetic circuit 13 by a reaction caused when the drive coil 14 and the diaphragm 12 are driven relative to the frame 11.

As illustrated in FIG. 2, a shaft 21A is fixed to a back surface of the first magnetic circuit 13A and a shaft 21B is fixed to a back surface of the second magnetic circuit 13B. Each of the shafts 21A and 21B is, for example, a metal round rod, one ends of the shafts 21A and 21B are fixed to the back surfaces of the magnetic circuits 13 by screwing, welding, brazing, press fitting, or the like, respectively, and the other ends are connected to each other by a long nut 22. That is, the shafts 21A and 21B and the long nut 22 constitute the connector 20 that interconnects the first speaker 10A and the second speaker 10B.

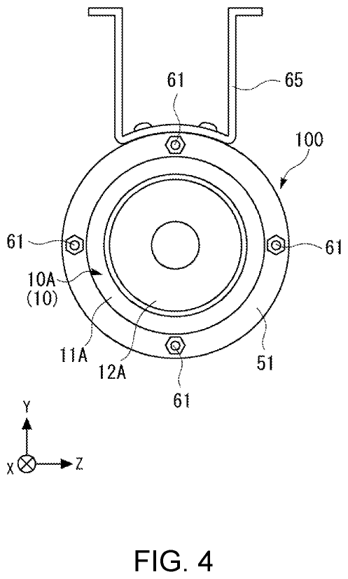

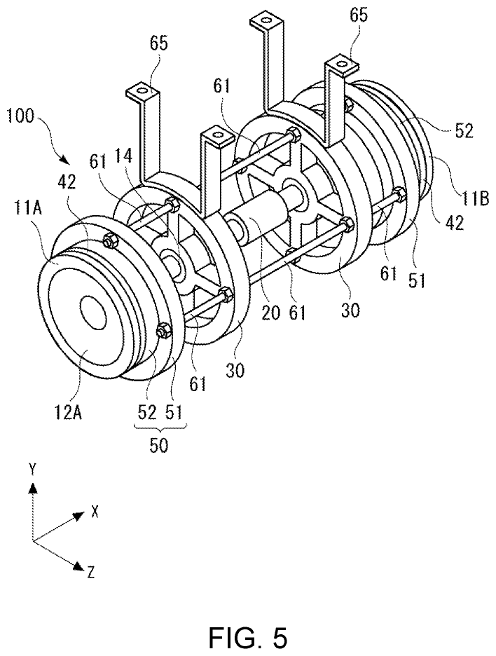

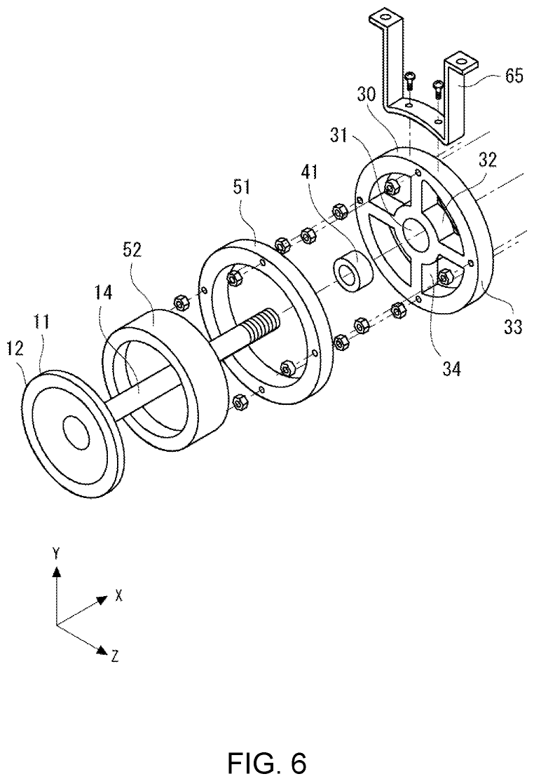

FIG. 4 illustrates the speaker unit 100 viewed from a side of the first speaker 10 A. FIG. 5 is a perspective view of the speaker unit 100. FIG. 6 is a partially exploded view of the speaker unit 100. In FIG. 4 to FIG. 6, an illustration of the interior material 101 is omitted.

The speaker cushioning material 42 having an annular shape is joined to a back surface of each of the first and second frames 11A and 11B in the first and second speakers 10A and 10B. Furthermore, a spacer 50 is joined to a back surface of the speaker cushioning material 42. The speaker cushioning material 42 has elasticity. Even when the first and second frames 11A and 11B are vibrated, the speaker cushioning material 42 is elastically deformed at a portion near the surface in contact with each of the first and second frames 11A and 11B so that the vibration is prevented from being transmitted to the spacer 50. As described above, the speaker cushioning material 42 holds the first and second frames 11A and 11B, has elasticity for damping the vibration transmitted from the first and second frames 11A and 11B, and is, for example, formed by a foam such as a polyolefin foam (PEF) or formed from a silicone resin, or the like.

The speaker cushioning material 42 for joining to the first speaker 10A is also referred to as a first speaker cushioning material 42 and the speaker cushioning material 42 for joining to the second speaker 10B is also referred to as a second speaker cushioning material 42. The spacer 50 for joining to the first speaker cushioning material 42 is also referred to as a first spacer 50 and the spacer 50 for joining to the second speaker cushioning material 42 is also referred to as a second spacer 50.

The spacer 50 is constituted by a cylinder 52 having substantially the same outer diameter as those of the frame 11 of the speaker 10 and the speaker cushioning material 42, and a flange 51 joining to the cylinder 52 and protruding radially outward from the cylinder 52.

Two stays 30 are provided between the first and second spacers 50 in an X-axis direction. Each of the stays 30 has substantially a disk shape and is constituted by a hub 32 having a hole 31 for passing the shafts 21A and 21B through in a center thereof, a rim 33 forming a periphery of each of the stays 30, and a spoke 34 for connecting the rim 33 and the hub 32.

The shafts 21A and 21B passed through the holes 31 of the stays 30 are fitted with connector cushioning materials 41 each having a cylindrical shape and the stays 30 hold the shafts 21A and 21B via the connector cushioning materials 41, respectively.

Each of the connector cushioning materials 41 has elasticity. Even when the shafts 21A and 21B are vibrated, each of the connector cushioning materials 41 is elastically deformed at a portion near the surface in contact with each of the shafts 21A and 21B so that the vibration is prevented from being transmitted to each of the stays 30. As described above, the connector cushioning materials 42 hold the shafts 21A and 21B, have elasticity for damping the vibration transmitted from the shafts 21A and 21B, and are, for example, formed by a foam such as a polyolefin foam (PEF) or formed from a silicone resin, or the like.

The first and second spacers 50 and the two stays 30 are connected by a fastening part (connecting member) 61. The fastening part 61 according to this embodiment is constituted by a bolt passing through a peripheral portion of each of the first and second spacers 50 and the two stays 30 and a nut fixing the first and second spacers 50 and the two stays 30 to the bolt.

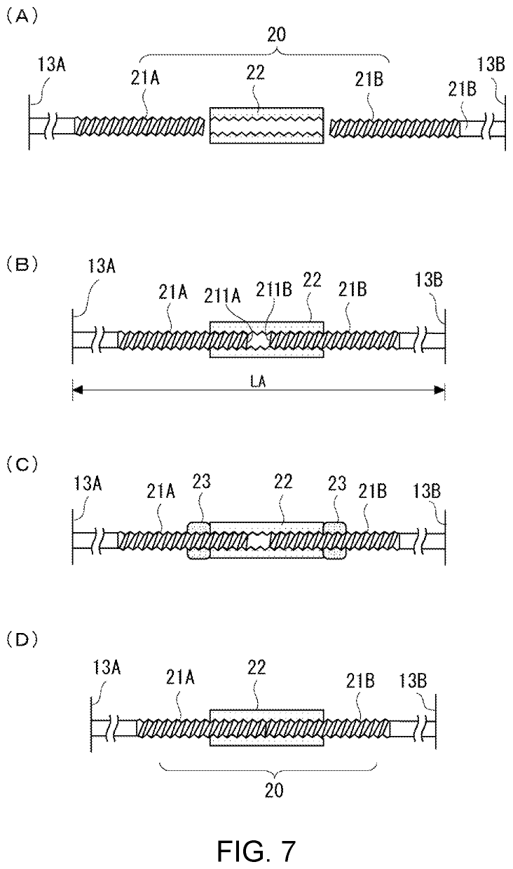

FIG. 7 illustrates a configuration of the speaker connector 20. As illustrated in FIG. 7 (A), each of the first and second shafts 21A and 21B has a screw thread at an end (rear portion) opposite to each of the first and second magnetic circuits 13A and 13B. The screw thread of the first shaft 21A is formed in an opposite direction to the screw thread of the second shaft 21B. Thus, as illustrated in FIG. 7 (B), a rear end 211A of the first shaft 21A and a rear end 211B of the second shaft 21B are screwed into the long nut 22 from both ends thereof. When the long nut 22 is rotated, the first and second shafts 21A and 21B are made to approach or separate from each other so that a distance LA between the speakers is adjusted. That is, the first and second shafts 21A and 21B and the long nut 22 constitute a turnbuckle.

As described above, the first and second spacers 50 are fixed by the fastening part 61 and a distance between the first spacer 50 and the second spacer 50 is maintained. Therefore, when the long nut 22 is fastened and the distance LA between the speakers is shortened, the rear surfaces of the first and second frames 11A and 11B are pressed and brought into close contact with the spacers 50 via the speaker cushioning materials 42, respectively. At this time, the long nut 22 is not fastened at maximum. The fastening of the long nut 22 is adjusted so that the first and second frames 11A and 11B are brought into close contact with the speaker cushioning materials 42 and elasticity of the speaker cushioning materials 42 permits a displacement of the first and second speakers 10A and 10B in an appropriate contact state. As described above, in this embodiment, the first speaker 10A, the second speaker 10B, the speaker connector 20, the first spacer 50, and the second spacer 50 are integrally connected by the fastening part 61.

Furthermore, as illustrated in FIG. 7 (C), the speaker connector 20 includes a lock nut 23 into which the first and second shafts 21A and 21B are screwed and the lock nut 23 may be fastened and fixed to the long nut 22. As illustrated in FIG. 7 (D), when the long nut 22 is fastened and the rear end 211A of the first shaft 21A is brought into contact with the rear end 211B of the second shaft 21B, the first speaker 10A may also be brought into appropriate contact with the second speaker 10B.

As illustrated in FIG. 4 and FIG. 5, a support member 65 is connected to an outer peripheral surface of each of the stays 30. One end of the support member 65 is connected to each of the stays 30 and the other end is connected to another member inside the center console, for example, a frame constituting a floor of the vehicle so as to support the speaker unit 100. Thus, the speaker unit 100 is installed in a state in which the first spacer 50 passes through a first hole 102A forming a first opening in the interior material 101 and the second spacer 50 passes through a second hole 102B forming a second opening in the interior material 101. That is, when the support member 65 is installed on another member, a mounting part (receiving part) of the support member 65 is provided in a predetermined position of another member so that the speaker unit 100 is installed in this state.

As described above, in a state in which the speaker unit 100 is supported by the support member 65, each of opening cushioning materials 43 is provided to fill a gap between the first spacer 50 and an inner wall surface of the first hole 102A (FIG. 2) and a gap between the second spacer 50 and an inner wall surface of the second hole 102B.

Each of the opening cushioning materials 43 has elasticity. Even when the first and second spacers 50 are vibrated, each of the opening cushioning materials 43 is elastically deformed at a portion near the surface in contact with each of the first and second spacers 50 so that a gap between each of the openings of the interior material 101 and each of the spacers 50 is closed and sealed. As described above, each of the opening cushioning materials 43 has elasticity and is, for example, formed from a synthetic resin such as rubber or a silicone resin or formed by a foam such as a polyethylene foam, a polyurethane foam, a polyolefin foam (PEF), or the like.

### Operation and Effects of Embodiment

As described above, according to the speaker unit 100 according to this embodiment, since the first and second speakers 10A and 10B are installed in the interior material 101 via the spacers 50 and the opening cushioning materials 43 without any gaps, respectively, the interior material 101 is functioned as a housing of the speaker unit 100. For example, if the speaker unit 100 is configured as a speaker apparatus stored in a housing separate from the interior material 101, a large housing having a volume of about 10 L is required. Thus, it is difficult to arrange the speaker unit 100 stored in such a housing inside the center console, because the housing is interfered with another member inside the center console. On the other hand, in this embodiment, since the interior material 101 is used as the housing of the speaker unit 100 without providing any separate housings and the entire space inside the center console is utilized as a space of the housing, the speaker unit 100 can be miniaturized.

The speaker unit 100 according to this embodiment is, for example, a subwoofer to which an audio signal in a low frequency band is input through a low pass filter and that mainly outputs a low sound. Here, it is preferable that the same signal is supplied to the first and second speakers 10A and 10B and the same sound is simultaneously generated from each of the speakers 10A and 10B. Since the first and second speakers 10A and 10B are arranged so that back surfaces of the first and second speakers 10A and 10B are opposite to each other, when the same audio signal is input to the first and second speakers 10A and 10B, the first and second speakers 10A and 10B are vibrated in opposite directions from each other and mutual vibrations are canceled by the speaker connector 20 that interconnects the magnetic circuits 13A and 13B arranged on the back surfaces of the first and second speakers 10A and 10B, respectively. Thus, it is possible to suppress unnecessary vibrations caused from the first and second speakers 10A and 10B.

Furthermore, in the speaker unit 100 according to this embodiment, the first and second speakers 10A and 10B and the speaker connector 20 are held by the first and second spacers 50 and the stays 30 via the speaker cushioning materials 42 and the connector cushioning materials 41, respectively. Therefore, unnecessary vibrations caused from the first and second speakers 10A and 10B are prevented from being transferred to the first and second spacers 50 and the stays 30. As a result, even when the speaker unit 100 is installed in the interior material 101, the vibrations are prevented from being transferred to the interior material 101 via the spacers 50 and the stays 30 and sounding of the interior material 101 is prevented.

Furthermore, according to the speaker unit 100 according to this embodiment, since the first and second speakers 10A and 10B, the speaker connector 20, the first and second spacers 50 are integrally configured as one unit, when the first and second holes 102A and 102B of the interior material 101 are provided, the speaker unit 100 is easily installed in any place of the vehicle.

<First Modification 1>

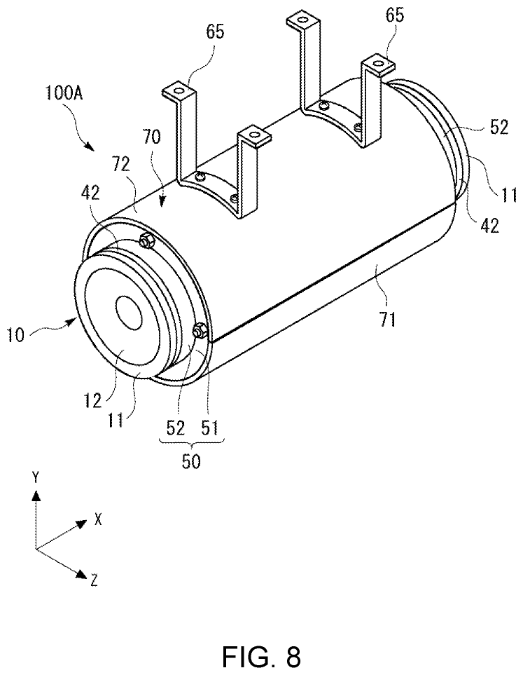

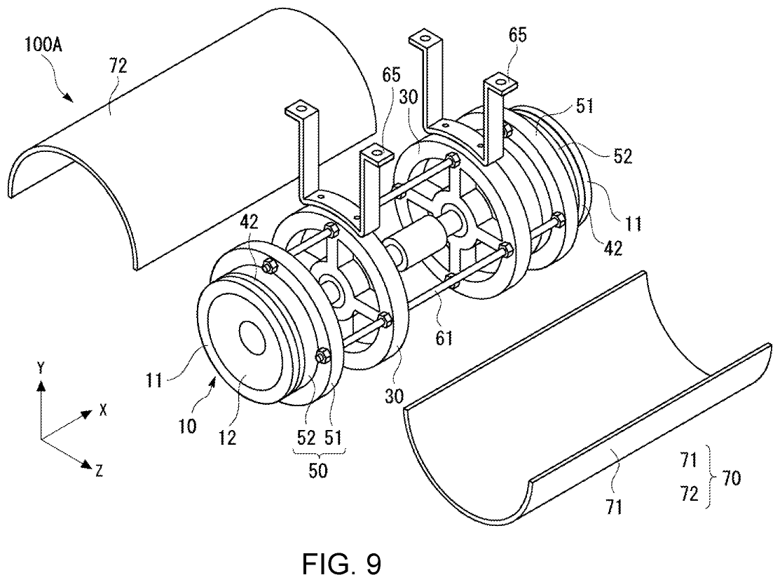

FIG. 8 is a perspective view of a speaker unit 100A according to a first modification. FIG. 9 is an exploded perspective view of the speaker unit 100A according to the first modification.

The first modification is different from the first embodiment described above in that the speaker unit 100A includes a cover 70 that covers a space on a back-surface side of each of first and second speakers 10A and 10B. Since other configurations are the same as in the first embodiment, the same elements are denoted with the same reference numerals, and redundant description is omitted.

As illustrated in FIG. 8 and FIG. 9, the cover 70 has a cylindrical shape and covers the space on the back-surface side of each of the first and second speakers 10A and 10B along outer peripheral surfaces of spacers 50 and stays 30. That is, the cover 70 separates a back-surface space from an external space of the speaker unit 100A.

The cover 70 crosses a cylinder in an X-axis direction and is constituted by divided portions, i.e., a lower cover 71 and an upper cover 72. The lower cover 71 is mounted on the outer peripheral surfaces of the spacers 50 and the stays 30 from a lower side of the speaker unit 100A and is fixed to the spacers 50 and the stays 30 by a screw, etc. Similarly, the upper cover 72 is mounted on the outer peripheral surfaces of the spacers 50 and the stays 30 from an upper side of the speaker unit 100A and is fixed to the spacers 50 and the stays 30 by a screw, etc. Support members 65 are mounted on the stays 30 via the upper cover 72 from an outside of the upper cover 72, respectively.

Similar to the first embodiment described above, the speaker unit 100A according to the first modification is installed in an interior material 101 via each of opening cushioning materials 43 in a state in which the spacers 50 pass through holes 102A and 102B of the interior material 101, respectively. Thus, since the interior material 101 functions as an enclosure of the speaker unit 100A, the cover 70 does not need to be configured as tight as an enclosure in a conventional speaker apparatus. For example, the cover 70 does not need to seal the space on the back-surface side of each of the first and second speakers 10A and 10B and may be provided with a predetermined size of opening. In this case, a resonance frequency determined by the size of the opening and a volume of the space inside the cover may be set outside a reproduction frequency band corresponding to the speaker unit 100A so as to adjust acoustic characteristics.

As described above, according to the first modification, even when sealing performance of the space partitioned by the interior material 101 is not sufficient as the enclosure, the cover 70 supplements a function of the enclosure so that the interior material 101 is used as the enclosure.

<Second Modification>

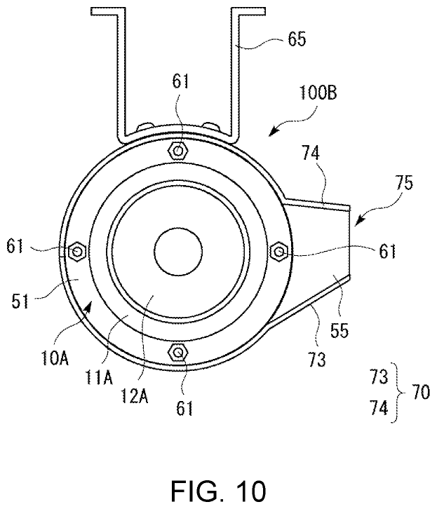

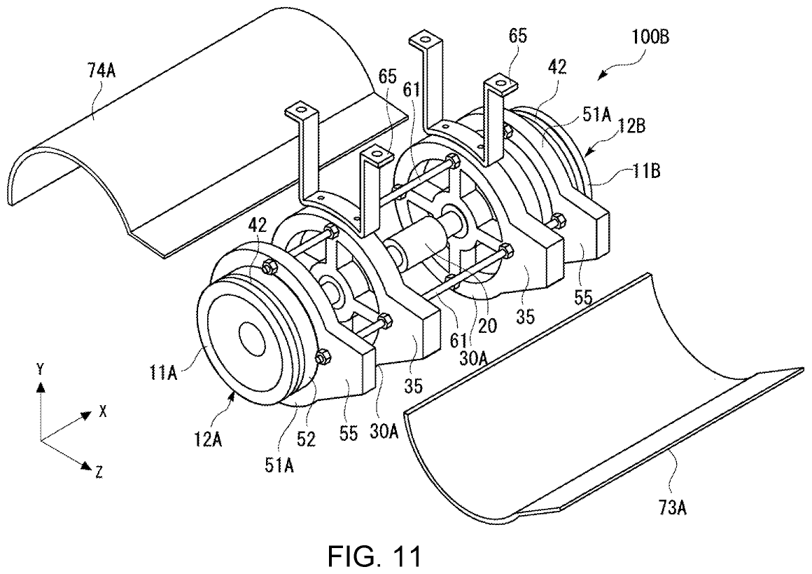

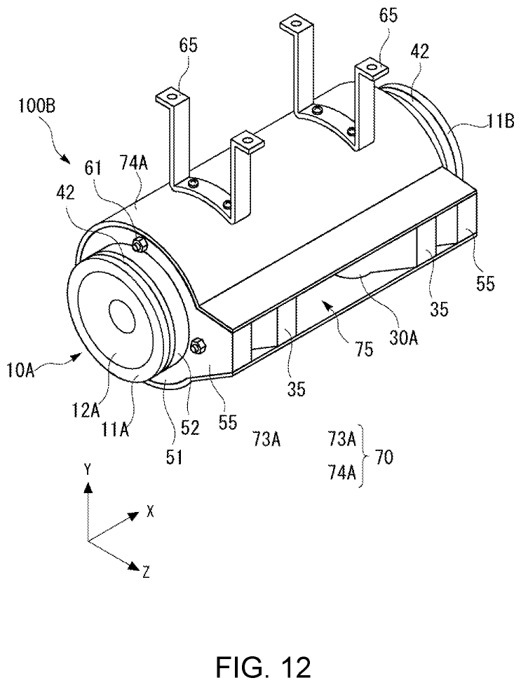

FIG. 10 illustrates a speaker unit 100B according to a second modification viewed from a front side of a speaker A. FIG. 11 is an exploded perspective view of the speaker unit 100B according to the second modification. FIG. 12 is a perspective view of the speaker unit 100B according to the second modification.

The second modification is different from the first embodiment described above in that the speaker unit 100B includes a cover 70 that covers a space on a back-surface side of each of first and second speakers 10A and 10B and a duct that communicates the space inside the cover with an outside of the cover. Since other configurations are the same as in the first embodiment, the same elements are denoted with the same reference numerals, and redundant description is omitted.

A spacer 50 according to the second modification has a protrusion 55 protruding radially outward from a part of an outer periphery of a flange 51. Furthermore, a stay 30 according to the second modification has a protrusion 35 protruding radially outward from a part of an outer periphery of the stay 30.

As illustrated in FIG. 11 and FIG. 12, the cover 70 has substantially a cylindrical shape and covers the space on the back-surface side of each of the first and second speakers 10A and 10B along outer peripheral surfaces of the spacers 50 and the stays 30. That is, the cover 70 separates a back-surface space from an external space of the speaker unit 100B.

The cover 70 is constituted by a lower cover 73A and an upper cover 74A. The lower cover 73A is mounted on the outer peripheral surfaces of the spacers 50 and the stays 30 and lower surfaces of the protrusions 55 and 35 from a lower side of the speaker unit 100B and is fixed to the spacers 50 or the stays 30 by a screw, etc. Similarly, the upper cover 74A is mounted on the outer peripheral surfaces of the spacers 50 and the stays 30 and upper surfaces of the protrusions 55 and 35 from an upper side of the speaker unit 100B and is fixed to the spacers 50 or the stays 30 by a screw, etc. Support members 65 are mounted on the stays 30 via the upper cover 74A from an outside of the upper cover 74A, respectively. Thus, the cover 70 separates the space on the back-surface side of each of the first and second speakers 10A and 10B from an installation space of the speaker unit 100B. In the second modification, a duct 75 is provided at a part of the cover 70 and communicates the back-surface space with other spaces formed separately from the installation space.

Here, other spaces include, for example, a space inside a vehicle dashboard, an air conditioner duct, an internal space of a skeleton member such as a rocker panel or a side sill, a trunk, a space outside a vehicle, or the like, and may be a space separated by a wall from a vehicle cabin. Since an interior material 101 is not designed only for installing the speaker unit 100B, in some cases, a volume of a space partitioned by the interior material 101 and sealing performance thereof are not sufficient as the enclosure. Even in this case, according to the second modification, by releasing a pressure inside the cover 70 to a space other than the space partitioned by the interior material 101 via the duct 75, it is possible to provide a sufficient volume on the back-surface side.

<Third Modification>

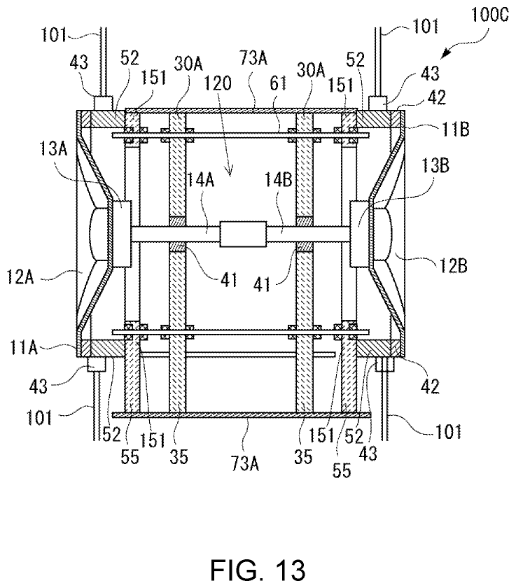

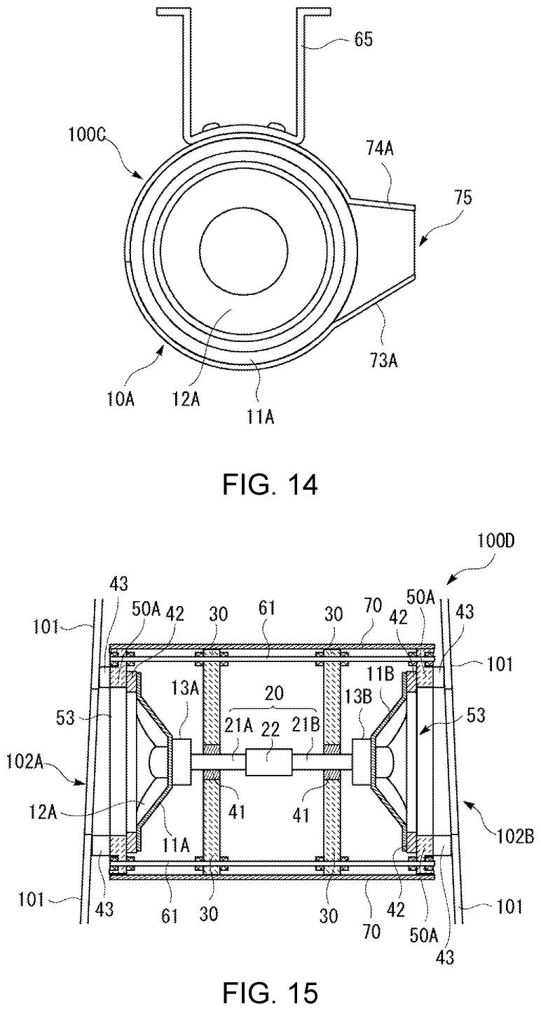

FIG. 13 is a schematic cross-sectional view illustrating a configuration of a speaker unit 100C according to a third modification. FIG. 14 illustrates the speaker unit 100C according to the third modification viewed from a front side of a speaker 10A.

The third modification is different from the second modification described above in that the speaker unit 100C includes a cover 70 that covers a space on a back-surface side of each of first and second speakers 10A and 10B and has substantially the same outer diameter as those of the first and second speakers 10A and 10B. Since other configurations are the same as in the second modification, the same elements are denoted with the same reference numerals, and redundant description is omitted.

A flange 151 and a stay 30A according to the third modification, when viewed in a direction of an X-axis direction, have substantially the same diameter as those of the first and second speakers 10A and 10B except for parts of projections 55 and 35. As a result, the flange 151 and the stay 30A are fastened by a fastening part (connecting member) 61 on a more central side than a cylinder 52 of a spacer 50.

The cover 70 is constituted by a lower cover 73A and an upper cover 74A. The lower cover 73A is mounted on outer peripheral surfaces of the flanges 151 and the stays 30A and lower surfaces of the protrusions 55 and 35 from a lower side of the speaker unit 100C and is fixed to the flanges 151 or the stays 30A by a screw, etc. Similarly, the upper cover 74A is mounted on the outer peripheral surfaces of the flanges 151 and the stays 30A and upper surfaces of the protrusions 55 and 35 from an upper side of the speaker unit 100C and is fixed to the flanges 151 or the stays 30A by a screw, etc.

As described above, in the third modification, since an outer diameter of the space 120 on the back-surface side of the first and second speakers 10A and 10B covered by the cover 70 has substantially the same outer diameter as those of the first and second speakers 10A and 10B, when the same speakers 10A and 10B as in the second modification are used, the space 120 on the back-surface side is reduced compared to the second modification, and thereby the speaker unit 100C is configured to be compact. Thus, even when the space 120 covered by the cover 70 is reduced, since a pressure inside the space 120 is released to an installation space of the speaker unit 100C, it is possible to obtain appropriate acoustic characteristics.

### Second Embodiment

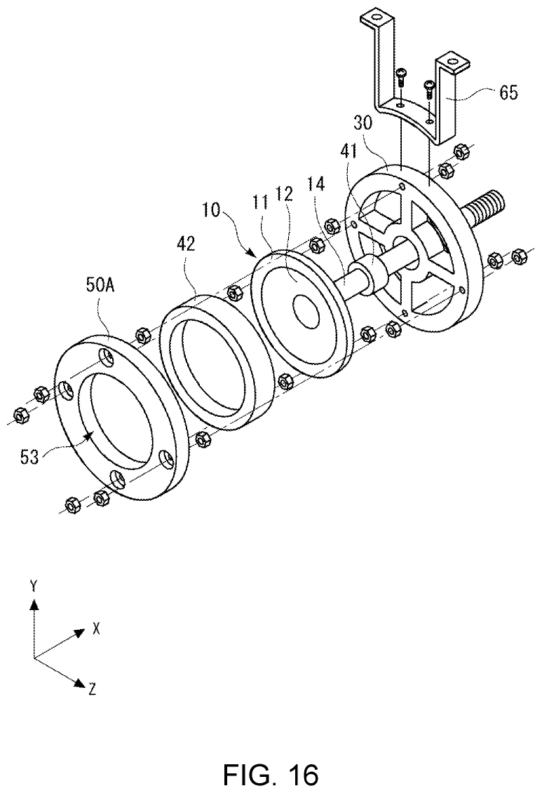

FIG. 15 is a schematic cross-sectional view illustrating a configuration of a speaker unit 100D according to a second embodiment. FIG. 16 is a partially exploded perspective view of the speaker unit 100D according to the second embodiment.

The second embodiment is different from the first embodiment described above in that each of spacers 50A is provided on a front surface side of each of first and second speakers 10A and 10B. Since other configurations are the same as in the first embodiment, the same elements are denoted with the same reference numerals, and redundant description is omitted.

On a front surface of each of frames 11A and 11B of the speakers 10A and 10B, a speaker cushioning material 42 having an annular shape is arranged and on a front surface of the speaker cushioning material 42, each of the spacers 50A is arranged.

Each of the spacers 50A has an outer diameter larger than those of the speakers 10A and 10B and has substantially the same outer diameter as those of stays 30. As illustrated in FIG. 16, each of the spacers 50A has an annular shape and has an opening 53 having substantially the same diameter as that of a diaphragm 12 provided on each of the first and second speakers 10. Furthermore, the opening 53 of each of the spacers 50A has an outer diameter substantially the same or slightly larger than those of diaphragms 12A and 12B so that a sound that is output from the speakers 10A and 10B is caused to pass through the opening 53.

The first and second spacers 50A and two stays 30 are fastened by a fastening part 61. The fastening part 61 is constituted by a bolt passing through a peripheral portion of each of the first and second spacers 50A and the two stays 30 and a nut fixing the first and second spacers 50A and the two stays 30 to the bolt. At this time, the fastening part 61 brings the first and second spacers 50A into pressure contact with the frames 11A and 11B of the speakers 10A and 10B via the speaker cushioning materials 42, respectively. The fastening part 61 does not fix the speakers 10A and 10B to the spacers 50A so as not to be moved. The fastening part 61 brings the speakers 10A and 10B into close contact with the spacers 50A, respectively, so as to prevent leakage of the sound from the speakers 10A and 10B, and sets a distance between the spacers 50A so as to permit a displacement of the speakers 10A and 10B relative to the spacers 50A in an appropriate contact state.

The speaker unit 100D is installed in another member (a frame constituting a floor of a vehicle, etc.) inside a center console by a support member 65. As a result, the speaker unit 100D is installed in a state in which each of the first and second spacers 50A is directed to each of first and second holes 102A and 102B provided in an interior material 101.

An opening cushioning material 43 having an annular shape is provided to fill a gap between the first spacer 50A and the interior material 101.

As described above, since the first and second speakers 10A and 10B are installed in the interior material 101 without any gaps, the interior material 101 is functioned as a housing of the speaker unit 100D. Thus, in the second embodiment, as well as the first embodiment, it is possible to use a space inside the center console as a back-surface space of each of the speakers 10A and 10B and facilitate the installation.

<Fourth Modification>

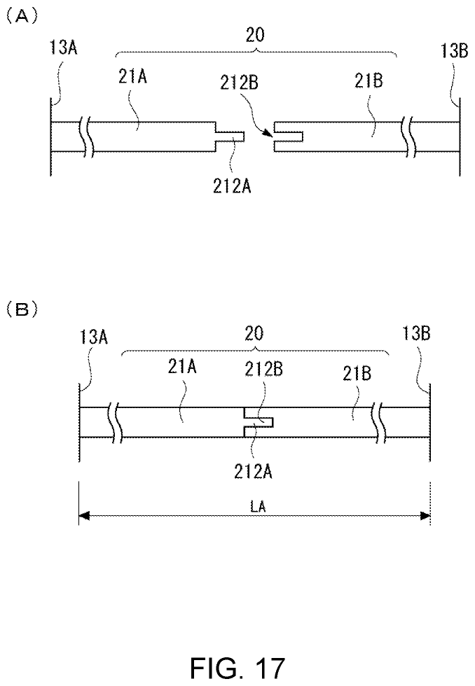

FIG. 17 illustrates a configuration of a speaker connector according to a fourth modification. In the second embodiment described above, although the first and second shafts 21A and 21B are connected to each other by the long nut 22, the invention is not limited thereto. Rear ends of first and second shafts 21A and 21B may be brought into contact with each other to connect first and second speakers 10A and 10B. Other configurations are the same as in the second embodiment.

In the fourth modification, as illustrated in FIG. 17(A), the first shaft 21A has a fitting projection 212A having a columnar shape at a rear end and the second shaft 21B has a fitting recess 212B having a columnar shape at a rear end so that a center axis of the rear end of the first shaft 21A is aligned with and a center axis of the rear end of the second shaft 21B.

When the speaker unit 100D is assembled, as illustrated in FIG. 17 (B), the fitting projection 212A at the rear end of the first shaft 21A is fitted into the fitting recess 212B of the second shaft 21B. As described above, since the first and second speakers 10A and 10B are brought into pressure contact with the first and second spacers 50A, respectively, the rear ends of first and second shafts 21A and 21B are brought into contact with each other. Thus, in the first and second speakers 10A and 10B according to the fourth modification, magnetic circuits 13A and 13B are interconnected to each other on back surfaces of the first and second speakers 10A and 10B so that mutual vibrations are canceled.

According to the fourth modification, it is possible to connect the first and second speakers 10A and 10B without using a fastening member, such as a long nut, and to simplify a configuration.

In the embodiments and modifications described above, although an example in which the speaker unit is installed inside the center console of the vehicle has been described, the invention is not limited thereto. The speaker unit may be installed in a space separated by a wall from a vehicle cabin, such as a skeleton member such as a rocker panel or a side sill, an air conditioner duct, a trunk, etc. Without being limited to the vehicle, the speaker unit may be installed in a space separated by a wall from a space in which a user who listens to a sound output from the speaker unit exists, such as an attic of a building, a closet, etc. As a result, also in the building, it is possible to effectively use the space separated by the wall as the enclosure of the speaker unit and to prevent sounding of the wall.

While the invention has been shown and described in detail, the foregoing description is in all aspects illustrative and not restrictive. It is therefore understood that numerous other modifications and variations can be devised without departing from the scope of the invention.

What is claimed is:

1. A speaker unit having at least a part that is installed in a first space separated by a wall from a second space in which a sound to be output by the speaker unit is listened to, the speaker unit comprising:
a first speaker;
a second speaker;
a speaker connector that interconnects the first speaker and the second speaker so that back surfaces of the first speaker and the second speaker oppose each other;
a first spacer that interconnects the first speaker and a first opening of the wall; and
a second spacer that interconnects the second speaker and a second opening of the wall, wherein
the first speaker, the second speaker, the speaker connector, the first spacer and the second spacer are integrally connected to each other.

2. The speaker unit according to claim 1, further comprising:
a connecting member that interconnects the first spacer and the second spacer.

3. The speaker unit according to claim 1, further comprising:
a stay that holds the speaker connector via a connector cushioning material having elasticity.

4. The speaker unit according to claim 1, further comprising:
a cover that surrounds the first spacer and the second spacer and forms a back-surface space of each of the first speaker and the second speaker, wherein
the cover is provided with a duct that communicates the back-surface space with other spaces different from the second space in which the sound to be output by the speaker unit is listened to.

5. The speaker unit according to claim 1, wherein
the first spacer is connected to the first opening via a first speaker cushioning material and the second spacer is connected to the second opening via a second speaker cushioning material.

6. The speaker unit according to claim 5, wherein
the first spacer is passed through the first opening and the second spacer is passed through the second opening.

7. The speaker unit according to claim 1, wherein
the wall is an interior wall of a vehicle or of a building.

8. The speaker unit according to claim 5, wherein
the wall includes a protrusion protruded to a vehicle cabin or a room in a building, the vehicle cabin or the room corresponding to the second space in which the second to be output by the speaker unit is listened to, and each of the first and second openings is provided in a surface opposite to the protrusion.
